(19) United States
(12) Patent Application Publication
(10) Pub. No.: US 2008/0033610 A1
(43) Pub. Date: Feb. 7, 2008

(54) Portable self-contained automobile entertainment and computing system

(76) Inventor: Adam Engel, Homestead, IA (US)

Correspondence Address: ALLAN L HARMS, 2750 FIRST AVENUE NE, SUITE 420, CEDAR RAPIDS, IA, 52402, US

(21) Appl. No.: 11/499,119

(22) Filed: Aug. 4, 2006

(51) Int. Cl. G06F 17/00

(52) U.S. Cl. 701/36; 701/1

(57) ABSTRACT

A computer and entertainment system for an automobile is housed in a portable enclosure that may be placed on the passenger seat or on the floor of the automobile. The computer and entertainment system is powered from the automobile 12VDC system by plugging a power cable into the dashboard cigarette lighter socket. The enclosure includes beverage cup holders and includes a padded lid that may serve as an arm rest. Wireless communication links include communication with wireless Internet hot spots and local home-based wireless networks enabling the portable automobile computer to self synchronize with a home-based computer.

### BACKGROUND OF THE INVENTION

This invention pertains to onboard computer and entertainment systems for motor vehicles.

Onboard computer information and entertainment systems have become available in high end and luxury automobiles. These take the form of limited purpose personal computers which are permanently installed in the dashboard or other compartments of the automobile and which allow the driver to perform limited functions, such as operating the onboard audio system, displaying maps, showing vehicle fuel usage, time information, and providing GPS information in vehicles equipped with GPS receiving equipment.

Aftermarket computers are also available which provide numerous discrete system components that must be individually installed and linked by wiring. None of the available computer systems allow the vehicle owner to easily move the computer system from the vehicle for convenience or security purposes, or to move the computer system to whatever vehicle in which the system owner decides to use the computer system. The aftermarket computer systems require extensive wiring effort to be performed in the vehicle to interconnect the CPU, the audio system, hard drive storage units, CD players, and other peripheral devices.

Laptop computers have been used as portable computers for use in motor vehicles but they are not typically equipped with 12VDC capability nor do they come equipped with peripheral equipment housed in a single housing.

A computer entertainment and information system which can be simply connected to the cigarette lighter or other standard 12VDC port of a motor vehicle would enable consumers to quickly add computer based information systems to existing vehicles, and would allow the easy removal of the computer system from the motor vehicle as desired without the need for cumbersome or damaging removal work.

A need also exists for a motor vehicle computer system that can automatically communicate with an owner's home-based computer system in order to synchronize the information contained on both the motor vehicle computer system and the home-based computer system.

### BRIEF SUMMARY OF THE INVENTION

The present invention provides a computer based entertainment and information system for a motor vehicle that integrates computer system components into a single housing that can be placed in the motor vehicle and connected to the 12VDC vehicle electrical system through the standard cigarette lighter outlet. The housing may be placed on an automobile passenger seat to also serve as an armrest and convenience accessory, or it may be placed on the floor of the passenger compartment.

A housing is provided with external beverage container holders and a general purpose personal computer including central processing unit (CPU), hard disk storage, a digital compact disk/video disk (CD/DVD) media drive, multiple input and output ports, wireless communication ability, and a multiple position touch screen display. The housing includes a power cable that terminates in a standard 12VDC auto plug that is mateable with the standard 12VDC socket (commonly known as the cigarette lighter socket) located on the vehicle dashboard or otherwise in the passenger compartment. The invention may optionally provide an FM transmitter, a printer, audio and video input and output connections, and a GPS antenna. The electronic components are interconnected and the CPU may communicate wirelessly with a keyboard or other input device, with wide area networks, and with any onboard audio system installed in the automobile. A compact disk control button pad is mounted to the exterior of the housing so that compact audio discs or digital video disk recordings located in the DVD/CD media drive may be played without opening the housing.

The housing is equipped with a lid that is hinged to the housing and may be opened to allow a display on a supporting arm to be rotated out of the housing to a generally upright position. The display may be an LCD display that can be positioned to stand above the housing. With the display support arm rotated to the operating position, the lid can be closed while the display remains in its operative position supported above the housing. The lid includes a padded outer surface that serves as a cushioned armrest when the lid is in its closed position. The display includes a touch sensitive face so that control instructions can be communicated to the CPU by touching designated regions of the display face.

In an alternative embodiment, the lid may house the display screen such that the display is observable by the user while the lid is in its open position. In this alternative embodiment the display may be selectively separated from the lid structure.

The CPU may control and provide signals to the FM transmitter that may transmit audio signals to the onboard FM radio receiver mounted in the vehicle.

The invention may receive Global Position System signals from the orbiting GPS satellite array to calculate and communicate location and position to the display.

The exterior of the housing is provided with one or more beverage cup holders that are accessible by the occupants of the motor vehicle.

Computer input devices such as a keyboard or pointing device wirelessly communicate with the CPU by way of “Bluetooth” or other wireless protocol technology. Touching of the display face is an available method to signal commands to the CPU.

The CPU includes control software that enables the invention to wirelessly communicate with a home-based computer system when the invention is brought into proximity to the home-based computer system, such as when the automobile is situated in the owner's driveway or near the owner's home. The CPU of the invention will then automatically wirelessly transmit information to the home-based computer system about changes made to the information stored on the invention since the last communication with the home-based computer system. This feature enables the owner of the invention to synchronize data changes on the user's home-based computer with that in the user's automobile-based computer without the user having to intervene, because the automobile-based computer initiates wireless communication and synchronization automatically upon detecting the local area network communicative with the home-based computer.

The following are objects of the invention:

(a) To provide a single housing which houses various computing, entertainment and information system devices in a single housing which is portable and which may be moved from one automobile to another;

(b) To provide a computer and entertainment system which may transmit audio information to an existing automobile audio system;

(c) To provide a console having an arm rest and cup holders which houses a computer and display and which is connected with the automobile electrical system only by connection with the 12VDC dashboard power outlet;

(d) To provide a self-contained computer and entertainment system which can be used to retrofit an automobile that has no entertainment computing system or GPS receiver and display;

(e) To provide an attractive and useful computer housing which can serve as a comfortable arm rest when positioned on the automobile passenger seat;

(f) To provide an integrated entertainment and GPS system for an automobile;

(g) To provide a motor vehicle entertainment system that provides a touch screen display that can be used to enter commands to the CPU of the entertainment system;

(h) To provide a computerized entertainment information system for an automobile which can deliver a wireless signal to an onboard FM radio from any location within the passenger compartment of the automobile;

(i) To provide a retrofit system to equip an automobile for reception of location information from the Global Positioning System Satellite array;

(j) To provide an automobile computer that has touch control performed by touching selected areas of the display;

(k) To provide a vehicle computer system that will automatically wirelessly link itself to a home-based computer in order to synchronize the information between the vehicle computer system and the home-based computer.

These and other objects of the invention will become apparent from examination of the description and claims that follow.

### BRIEF DESCRIPTION OF THE SEVERAL VIEWS OF THE DRAWING(S)

FIG. 1 is a front right perspective of a preferred embodiment of the invention with its display raised to an operating position.

FIG. 2 is a side rear perspective of the preferred embodiment of FIG. 1 with a sidewall partly cut away and shown with the housing lid thereof raised and with the display member raised to an operating position.

FIG. 3 is a diagrammatic representation of the electronic components of an automobile computer-based information and entertainment system according to the present invention.

FIG. 4 is a top plan view of the preferred embodiment with the lid omitted showing the display member in its stored position and the wireless keyboard member stored in the housing of the invention.

FIG. 5 is a schematic illustration of wireless communication between a vehicle-based unit of the invention of FIG. 1 and a home-based computer system when the vehicle carrying the invention is in proximity with the home in which the home-based computer system is housed.

FIG. 6 is a rear side perspective of an alternative embodiment of the invention.

### DETAILED DESCRIPTION OF THE INVENTION

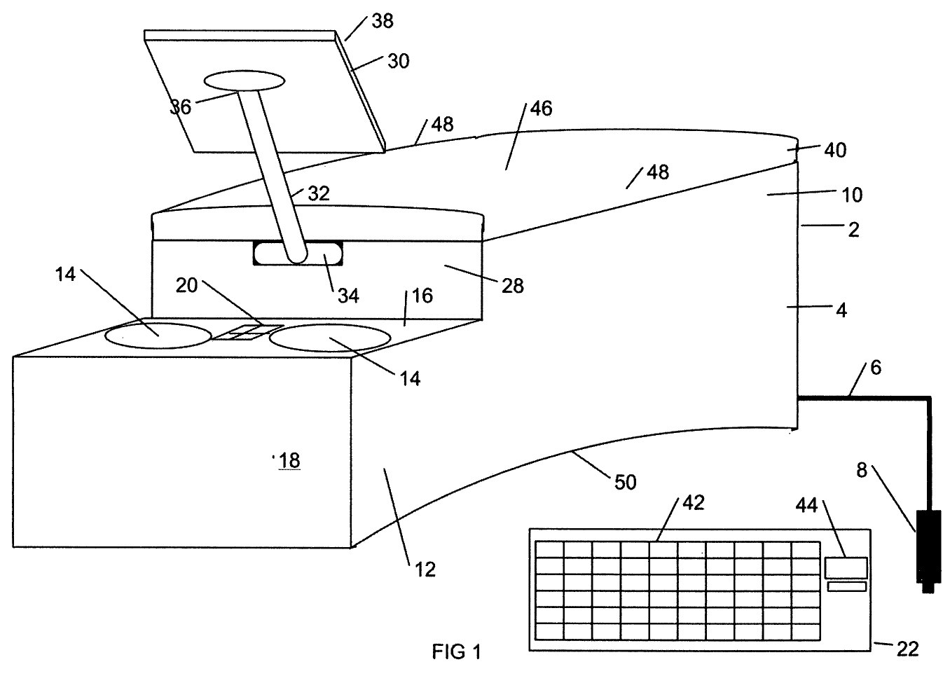

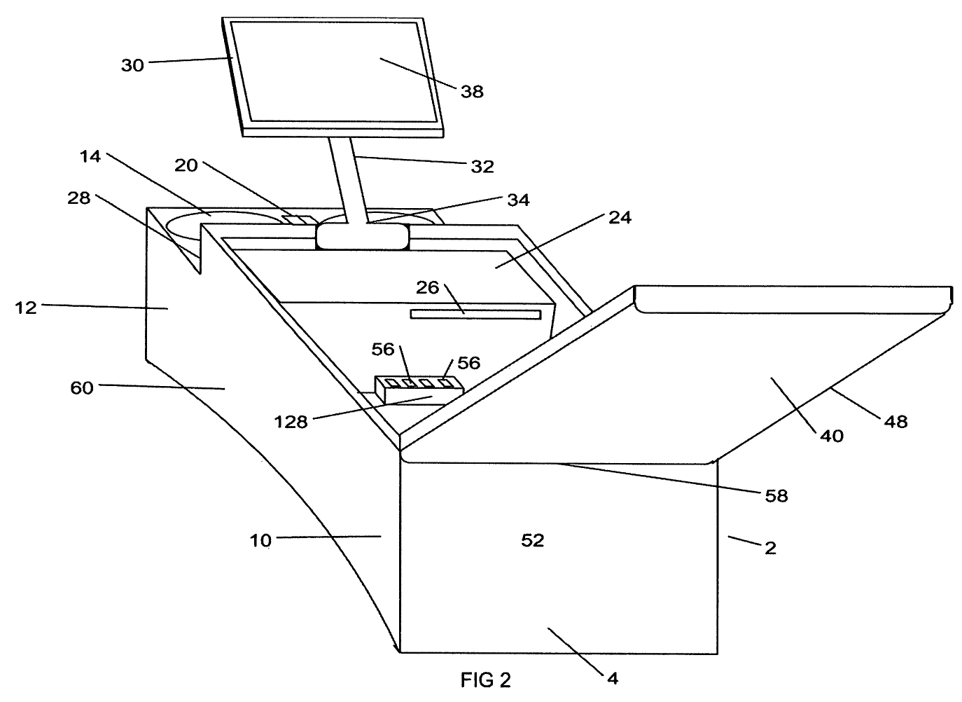

Referring to FIGS. 1-2 and initially to FIG. 1, invention 2 is seen to comprise an housing 4 from which a power cable 6 extends, terminating in a power plug 8 which is mateable with a standard 12VDC electrical socket present in most motor vehicles and usually mounted on or near the motor vehicle dashboard so that cigarette lighter heating plugs or other 12VDC powered devices may be plugged into the onboard 12VDC electrical system of the motor vehicle.

Housing 4 is elongate and preferably rectangular in shape such that housing 4 may be placed on the passenger seat of a motor vehicle such that a drive and a passenger may sit on opposing sides of housing 4. The length of housing 4 generally corresponds to the depth of an automobile passenger seat. Housing 4 is sufficiently narrow to allow it to be placed between spaced apart seats of a minivan or other automobile with empty space between the seats thereof. Computer compartment 10 of housing 4 is sufficiently tall and lid 40 is preferably provided with a padded upper surface 46 having rounded edges 48 such that upper surface 46 may serve as a cushioned arm rest for the driver and passenger seated adjacent invention 2.

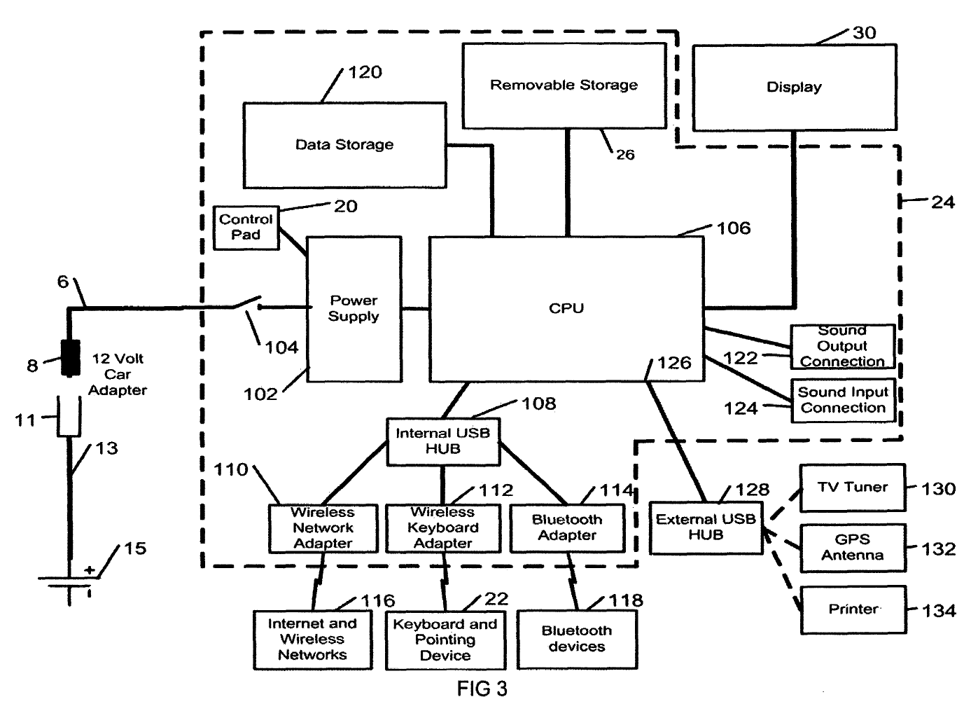

Housing 4 comprises a computer compartment 10 and a cup holder body 12 integrated into a single enclosure. Cup holder body 12 houses two beverage container receptacles 14 into which water bottles, soda cans, coffee mugs and the like may be selectively inserted for the convenience of the occupants of the motor vehicle. Configuration of cup holder body 12 may include a single receptacle 14 or more than two receptacles 14. A CD player controlling key pad 20 may be mounted to the top 16 of front wall 18 of the cup holder body 12 to allow the user to play recorded disk media which have been inserted into the CD/DVD drive mechanism 26 (See FIG. 3) of the computer assembly 24 installed within computer compartment 10.

Display member 30 is preferably a flat panel device that consumes minimal power, such as an LCD display. It is supported upon a moveable support arm 32 that terminates in pivot base 34. Pivot base 34 is hinged to the front wall 28 of computer compartment 10 such that display member 30 may be folded about pivot base 34 to a stored position under lid 40 of computer compartment 10.

Display member 30 is pivotably mounted to free end 36 of support arm 32 such that display member 30 may rotate about and tilt upon free end 36 so that the display member 30 thereof may be turned to a wide assortment of positions to accommodate the user who desires to view the display screen 38.

A keyboard assembly 22 is included in invention 2 and may be stored within computer compartment 10 when not in use. A user may enter commands to the computer assembly 24 by activating keyboard assembly 22, but a user may alternatively touch selected regions of the display screen 38 to make selections and thereby to enter commands to the computer assembly 24 contained within computer compartment 10. Keyboard assembly 22 may comprise a keyboard 42 and pointing device 44 as well as other input devices such as keypads, touch pads and track balls. If desired, a wireless mouse may be included with invention 2.

Bottom 50 of housing 4 may be gently concave from front wall 18 to rear 52 to generally conform to the curvature of an automobile seat or it may be planar as shown in FIG. 1 such that housing 4 will stably rest on the floor of a passenger compartment or on the passenger seat of the vehicle.

FIG. 2 provides a view of the internal components of housing 4 by showing lid 40 in its open position and first sidewall 60 partly cut away. Lid 40 is pivotable about upper end 58 of rear end wall 52 of housing 4. Computer assembly 24 is secured within computer compartment 10 and includes removable data storage drive mechanism 26 into which recordable media including CD's or DVD's may be loaded for reading data thereon, or for writing data thereto.

Control of the playback feature of removable data storage drive mechanism 26 may be accomplished through entry of key pushes on control pad 20 which is mounted to the exterior of housing 4, preferably on the top 16 of cup holder body 12. Of course keyboard commands and touch screen commands can also be used to cause playback of recorded media stationed in the removable storage drive mechanism 26.

Visual signals generated by computer assembly 24 may be viewed on display screen 38 of display member 30. In addition, operation commands for the CPU 106 within computer assembly 24 may be entered by manual touching of select locations on the touch sensitive display screen 38.

Display member 30 may be adjusted for viewing comfort by tilting or rotating display member 30 on support arm 32 which is joined to front wall 28 of computer compartment 10 by pivot base 34.

Removably coupled to computer assembly 24 at USB port 126 by USB cable 54 is external Universal Serial Bus (USB) hub 128 which includes multiple USB connectors 56 thereon.

Referring now to FIG. 3, the operative components of the invention 2 may be observed. The power plug 8 of power cable 6 may be received in the 12VDC socket 11 connected by wiring harness 13 to the battery 15 of the motor vehicle. The power cable 6 is directly connected to the power supply 102 through manual switch 104. Power supply 102 energizes CPU (central processing unit) 106 by converting and conditioning 12VDC power from the motor vehicle battery 15 to 5VDC and other voltages required by CPU 106 and other components.

CPU 106 is coupled by internal wiring to an internal USB hub 108 that couples wireless network adapter 110, wireless keyboard adapter 112 and Bluetooth adapter 114 to the signal bus of CPU 106. Input commands may be made to the CPU by manipulation of keyboard 42 and pointing device 44 that are wirelessly coupled to wireless keyboard adapter 112. Therefore keyboard 42 and pointing device 44 may be moved about the passenger cabin of the motor vehicle in which invention 2 is located while maintaining the ability for a user to enter selections and commands to the CPU 106 via the keyboard 42 and pointing device 44.

The display member 30 is directly coupled to CPU 106 such that output information from the CPU may be displayed on the display member 30, and so that selections entered by touching the display screen 38 are communicated to CPU 106.

In addition to the wireless interface provided by keyboard adapter 112, two other wireless adapters 110, 114 are coupled to CPU 106 through internal USB hub 108. Wireless network adapter 110 acts as a signal transmission and receiving device for wireless communications with information networks 116 such as wide area networks (Internet “Hot Spots”) or local area networks from which access to other computer systems may be achieved. CPU 106 can therefore communicate with a global information network through Internet “Hot Spots” when the motor vehicle is driven into range of such “Hot Spots.”

The Bluetooth adapter 114 allows the CPU 106 to communicate with proximal Bluetooth enabled devices 118 to establish low power piconetworks. Examples of possible Bluetooth enabled devices 118 are cell phones and GPS receivers. In addition, some keyboards and pointing devices (computer mice) are Bluetooth enabled. Therefore Bluetooth enabled devices 118 may be communicative with the CPU 106. Because of the spread spectrum frequency hopping of Bluetooth devices, and the low power outputs of such devices, many Bluetooth devices may concurrently communicate with the CPU 106 at a given time.

Incorporated within the computer assembly 24 are at least one data storage hard drive 120 and a removable data storage drive mechanism 26 such as a CD drive, a DVD drive, or a combination CD/DVD drive. In order for the invention 2 to operate as an entertainment device, music encoded CD's may be inserted in the removable data storage drive mechanism 26 followed by instructions to the CPU 106 made via the keyboard device 22 or by selections on the touch screen features of the display member 30 or through use of the CD key pad 20 mounted to the exterior of the housing 4.

In the case when a prerecorded DVD is inserted into the removable data storage drive mechanism 26, audible and visual information may be provided to the user with the visual information displayed by the display member 30 and the audible information transmitted via the Bluetooth adapter 114 to the onboard car stereo system if Bluetooth equipped, or through a loudspeaker (not illustrated) coupled to the sound output connection 122 which is coupled to the CPU 106.

If the CPU 106 is appropriately programmed with voice activation software, oral commands may be made by a user to a microphone (not illustrated) incorporated within or coupled to the sound input connection 124 such that the oral commands may be digitized and used to control the CPU 106 or to cause CPU 106 to communicate to output devices, such as Bluetooth enabled cell phones.

In the case when a user desires to record data to a CD or DVD which is recordable, sound input may be communicated to the CPU by the sound input connection 124 which is coupled to the CPU 106 by internal wiring. The sound information conveyed to the CPU 106 may be digitized therein and delivered to the removable data storage drive mechanism 26 to be permanently recorded, or to the data storage hard drive 120 to be stored and selectively retained.

A USB port 126 on the CPU 106 may be selectively coupled to USB compatible devices or to an external USB hub 128 to which optionally a television tuner 130, a GPS antenna 132 or a printing device 134 may be selectively coupled.

It should be understood that the CPU 106, power supply 102, switch 104, data storage hard drive 120, removable data storage drive mechanism 26, sound output connection 122, sound input connection 124, internal USB hub 108, wireless network adapter 110, wireless keyboard adapter 112 and Bluetooth adapter 114 are preferably all included in the computer assembly 24.

By equipping invention 2 with various input and output technologies, all of which are integrated and contained in a single housing, the user may utilize the invention 2 to play music CD's in the removable data storage drive mechanism 26 and have the aural information delivered to the onboard car stereo via Bluetooth adapter 114 or by the sound output connection 122 to a loudspeaker.

The CPU may be programmed with Global Positioning System (GPS) signal computing software such that an optional GPS antenna 132 within line of sight of at least three of the satellites in the Global Positioning System array can receive GPS information and communicate it to the CPU for processing such that position and direction information may be displayed to the user on the display member 30. Accumulating GPS data may be stored on the data storage hard drive 120 or recorded on a blank CD or DVD stationed in the removable data storage drive mechanism 26.

Because all components of computer assembly 24 are housed in housing 4 with display member 30 mounted physically to the housing, it can be understood that only a power connection need be made to the motor vehicle system to permit the invention 2 to be operable. Hence the invention 2 may be disconnected from the 12VDC onboard power socket 11 and the entire unit moved to another vehicle, regardless of the level of information technology present in the second motor vehicle. Of course, if the user desires to remove the invention 2 from the motor vehicle for safekeeping, that may be easily accomplished.

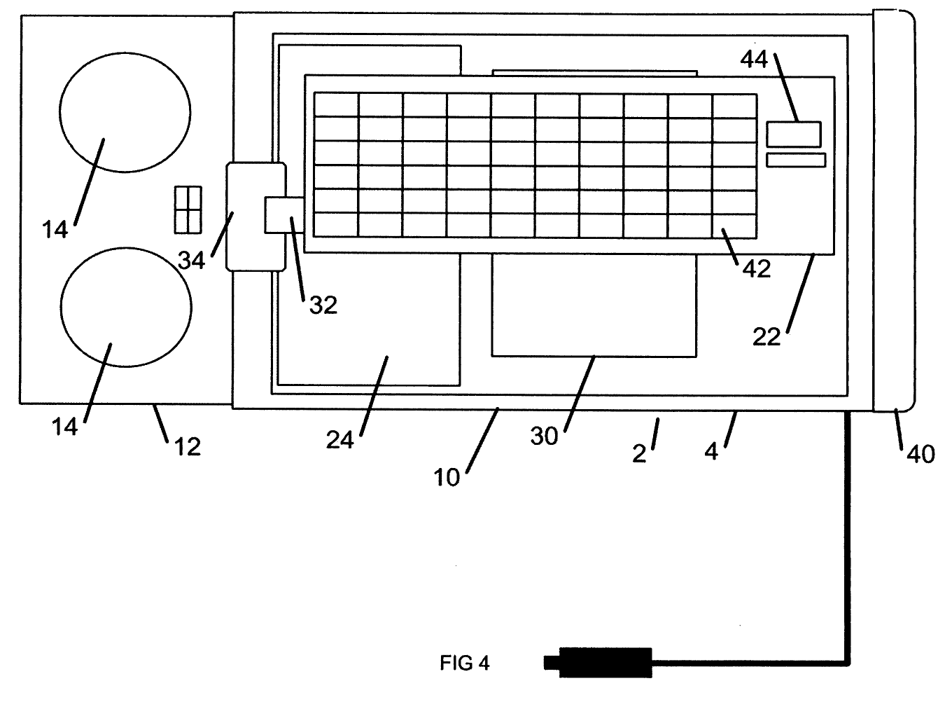

FIG. 4 discloses invention 2 in a top view with the lid omitted. The keyboard assembly 22 is shown stored within computer compartment 10 overlying the computer assembly 24 and the display member 30 which is shown in its stored position with support arm 32 thereof pivoted about pivot base 34 to a generally horizontal position. Beverage container receptacles 14 remain accessible to a motor vehicle occupant to temporarily store beverage containers therein. With display member 30 so stored, recorded media present in the removable data storage drive mechanism 26 can still be played by use of exterior control keypad 20.

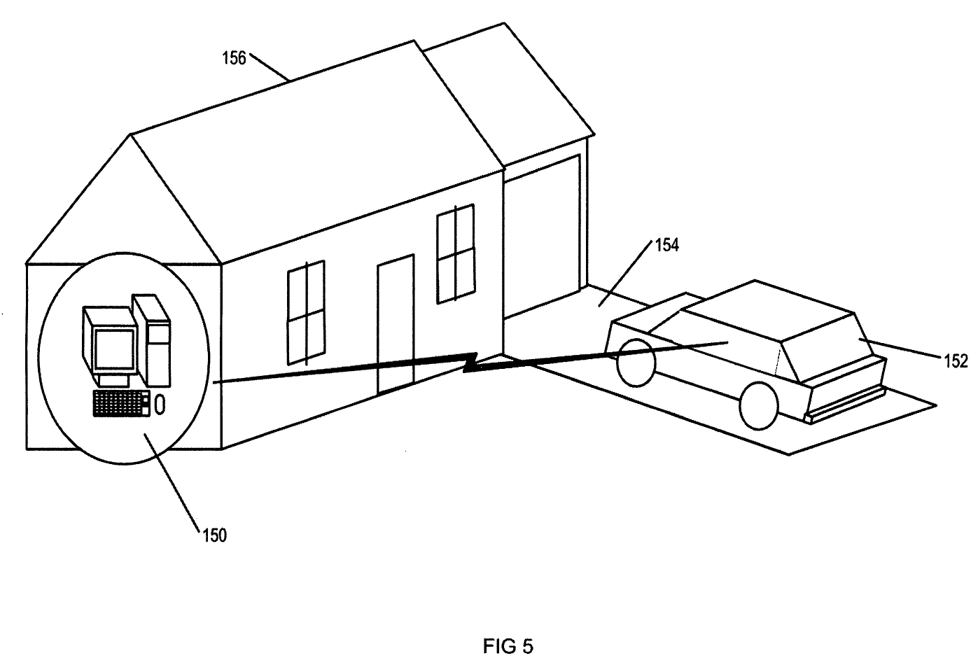

FIG. 5 illustrates a motor vehicle 152 entering the driveway 154 of a home 156 and coming in range of the wireless communication signals of a home-based computer system 150. Upon sensing the presence of the home-based computer system 150 in range for wireless communication, the invention 2 within vehicle 152 will establish a secure wireless connection in order to share data with the home-based computer system 150.

Referring to FIG. 5 along with FIG. 3, the wireless network adapter 110 permits the CPU 106 to shake hands with a home-based computer 150 such that a data communication link may be wirelessly established when the invention 2 comes within communication range of the home-based computer system 150. The CPU 106 may be programmed to automatically communicate with the home-based computer system 150 to update the data storage unit of the home-based computer system 150 with changes to the stored data which have occurred while the user was away from home in the invention equipped motor vehicle. For instance, if the invention 2 has been utilized to download purchased music or video files from an Internet vendor by use of the wireless network adapter 110, the new files stored on the data storage hard drive 120 may be transferred wirelessly to the home-based computer system 150.

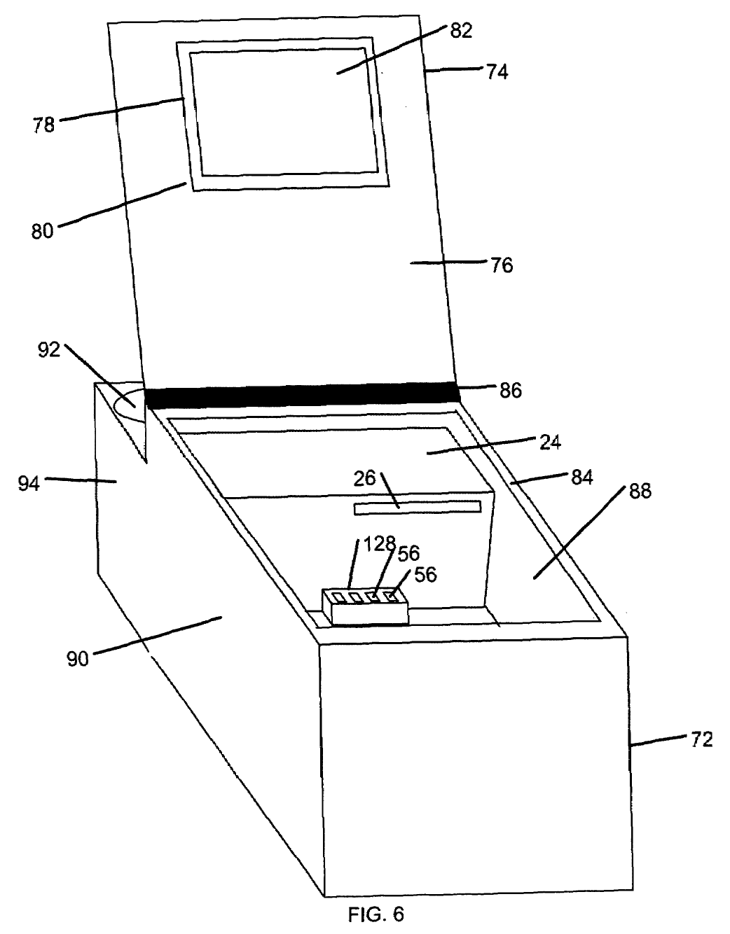

FIG. 6 illustrates an alternative embodiment of the invention wherein housing 72 is provided with hinged cover 74 which includes display unit 76 which is removably received in a recess 78 in inside face 80 of cover 74 such that the display screen 82 of display unit 76 can be viewed when cover 74 is raised to its open position as shown in FIG. 6.

Cover 74 is hinged to top 84 of housing 72 by hinge 86 such that lid 74 may be rotated about hinge 86 to overlie top opening 88 of housing 72.

Computer assembly 24 may be housed within first compartment 90 such that CD/DVD drive 26 may be accessed when lid 74 is raised to its open position.

Display unit 76 is selectively removable from recess 78 but is coupled to computer assembly 24 by a cable which passes through cover 74 and which is of sufficient length to permit display unit 76 to be repositioned and hand held if desired when display unit 76 is removed from recess 78 by a user. Excess cable length may be folded and stored within recess 78 beneath display unit 76 when display unit 76 is stationed within recess 78.

A USB hub 108 is coupled to a USB part of computer assembly 24 to join multiple USB compatible devices through USB connectors 56 to the USB signal bus of computer assembly 24.

Enclosure 72 further comprises at least one cup holder 92 supported within housing extension 94 integrated into housing 72. Cup holder 92 may be used to receive a beverage container regardless whether lid 74 is in open or closed position.

The foregoing description of the invention has been presented for purposes of illustration and description and is not intended to be exhaustive or to limit the invention to the precise form disclosed. Modifications and variations of the embodiments are possible in light of the above disclosure or such may be acquired through practice of the invention. The embodiments illustrated were chosen in order to explain the principles of the invention and its practical application to enable one skilled in the art to utilize the invention in various embodiments and with various modifications as are suited to the particular use contemplated. It is intended that the scope of the invention be defined by the claims appended hereto, and by their equivalents.

Having described the invention, I claim:

1. A portable computer system for a motor vehicle comprising
a central processing unit and data storage device housed in a housing,
the housing including one or more beverage container receptacles on an exterior thereof.

2. The portable computer system of claim 1 wherein
the central processing unit includes a wireless communication interface.

3. The portable computer system of claim 1 wherein
the central processing unit is coupled to a display member,
the display member supported on a first end of a repositionable support arm,
a second end of the support arm hinged to a sidewall of the housing,
whereby the display member may be moved between an operating position disposed exterior of the housing to a stored position below a lid enclosing the housing.

4. The portable computer system of claim 3 wherein
the display member includes a touch sensitive display screen,
whereby commands to the central processing unit may be entered by a user touching selected regions on the touch sensitive display screen.

5. The portable computer system of claim 1 wherein
a control keypad is mounted to an exterior of the housing,
the control keypad coupled to the central processing unit,
whereby control keys on the control keypad cause operation of a compact disk drive coupled to the central processing unit.

6. The portable computer system of claim 1 wherein
the central processing unit is coupled to an FM transmitter,
the FM transmitter broadcasting signals to an onboard FM radio installed in the motor vehicle.

7. The portable computer system of claim 1 wherein
a power cord coupled to a power supply of the central processing unit extends from the housing,
the power cord terminates in a plug matable with a 12VDC socket of an electrical system of the motor vehicle.

8. The portable computer system of claim 1 wherein
the housing comprises a lid hinged to a sidewall of the housing,
the lid having a padded top,
whereby the housing may serve as an arm rest for an occupant of the motor vehicle.

9. The portable computer system of claim 1 wherein
the central processing unit is coupled to a wireless communication element communicative with a wide area wireless network,
whereby the user of the central processing unit may communicate with a global information network when the central processing unit is in communication with the wide area wireless network.

10. The portable entertainment computer device of claim 1 wherein
the central processing unit includes wireless communication links,
the central processing unit sensing a local area network when in proximity thereto,
the central processing unit self-initiating communication with a home-based computer system which is authorized to communicate with the central processing unit through the local area network,
the central processing unit automatically transmitting data to the home-based computer system.

11. A portable computer system for a motor vehicle comprising
a central processing unit and data storage device housed in a housing,
a power cord coupled to a power supply of the central processing unit,
the power cord extending from the housing,
the power cord including a plug on a free end thereof,
the plug receivable in a 12VDC socket of an electrical system of the motor vehicle.

12. The portable computer system of claim 11 wherein
the enclosure comprises a padded top.

13. The portable computer system of claim 11 wherein
the enclosure comprises beverage containers receptacles on an exterior thereof.

14. A portable computer system for a motor vehicle comprising
a housing having a padded lid,
a central processing unit disposed in the housing,
a display member mounted to the housing,
the housing sufficiently tall to provide an arm rest for a person seated adjacent the housing.

15. The portable computer system of claim 14 wherein
the display member is supported on a support arm pivotable upon a sidewall of the housing,
the display member in a stored position disposed within a cavity of the housing.

16. The portable computer system of claim 14 wherein
a global positioning system antenna is selectively coupled to the central processing unit,
whereby the global positioning system may calculate location information and display the location information on the display member.

17. The portable computer system of claim 14 wherein
the housing comprises at least one cup holder.

18. The portable computer system of claim 14 wherein
a keyboard is wirelessly communicative with the central processing unit.

19. The portable computer system of claim 14 wherein
an FM transmitter is coupled to an output of the central processing unit.

20. The portable computer system of claim 14 wherein
the central processing unit is coupled by wiring exterior to the housing only to a plug receivable in a 12VDC socket of an electrical system of the motor vehicle.
